(19) United States
(12) Patent Application Publication
(10) Pub. No.: US 2025/0349051 A1
(43) Pub. Date: Nov. 13, 2025

(54) MODIFICATION AND/OR ITERATIVE MODIFICATION OF MULTI-MODAL CONTENT USING GENERATIVE MODEL(S)

(71) Applicant: GOOGLE LLC, Mountain View, CA (US)

(72) Inventors: Ágoston Weisz, Zurich (CH); Michael Andrew Goodman, Oakland, CA (US)

(21) Appl. No.: 18/658,531

(22) Filed: May 8, 2024

(51) Int. Cl. G06T 11/60; G06F 3/16; G06T 13/80

(52) U.S. Cl. CPC G06T 11/60; G06F 3/16; G06T 13/80; G06T 2200/24; G06T 2210/12

(57) ABSTRACT

Implementations described herein relate to generating a modified version of visual content provided by a user and using various generative model(s) (GM(s)). Processor(s) of a system can: receive user input that includes the visual content and a request to modify the visual content; generate the modified version of the visual content; and cause the modified version of the visual content to be rendered for presentation to the user. The visual content can include, for example, image content, video content, and/or other forms of visual content. Further, the request to modify the visual content can include, for example, a request to modify portion(s) of the visual content, animate portion(s) of the visual content, add textual content that is related to the visual content, add audible content that is related to the image content, and/or other requests.

### BACKGROUND

Various generative model(s) (GM(s)) have been proposed that can be used to process user input(s), to generate output that reflects generative content that is responsive to the user input(s). For example, large language models (LLM(s)) have been developed that can be used to process user input(s), to generate LLM output that reflects text-based generative content that is responsive to the user input(s). Further, music generation models have been developed that can be used to process user input(s), to generate music generation output that reflects audio capturing music that is responsive to the user input(s). Moreover, image and video generation model(s) have been developed that can be used to process user input(s), to generate image and/or video generation output that reflects image-based and/or video-based generative content that is responsive to the user input(s).

However, in many instances, a user must interact with various disparate GM(s) to obtain generative content across different modalities. For instance, assume that the user wants to modify existing visual content, such as existing image content or existing video content, to change an object, features of the object, swap out the object, etc. In this example, the user may interact with an image generation model and/or video generation model to modify the existing visual content and to modify the object as desired. Further assume that the user wants to generate and add text and/or audio to supplement a modified version of the existing video content. In this example, the user may be required to interact with a separate text generation model, such as a separate LLM that is in addition to the image generation model and/or the video generation model, and with a separate audio generation model, such as a music language model that is in addition to the image generation model and/or the video generation model. However, these disparate interactions with these disparate GM(s) to obtain the desired modified version of the original visual content wastes computational resources by requiring these disparate interactions and also wastes network resources since these disparate GM(s) are typically executed at remote server(s) due to their size.

### SUMMARY

Implementations described herein relate to generating a modified version of visual content provided by a user and using various generative model(s) (GM(s)). Processor(s) of a system can: receive user input that includes the visual content and a request to modify the visual content; generate the modified version of the visual content; and cause the modified version of the visual content to be rendered for presentation to the user. In generating the modified version of the visual content, the processor(s) can process, using GM(s), GM input to generate GM output, the GM input including at least the user input and the visual content (or a representation thereof), and determine, based on the GM output, the modified version of the visual content. Notably, the visual content can include, for example, image content, video content, and/or other forms of visual content. Further, the request to modify the visual content can include, for example, a request to modify portion(s) of the visual content, animate portion(s) of the visual content, add textual content that is related to the visual content, add audible content that is related to the image content, and/or other requests. The processor(s) can continue receiving and processing additional user input(s) to iteratively modify the visual content.

In some implementations, the processor(s) can cause a single GM to process the GM input to generate the GM output, and the modified version of the visual content can be determined based on the GM output (or correspond to the modified version of the visual content itself). In other implementations, the processor(s) can cause multiple GMs to process respective GM inputs to generate respective GM outputs, and the modified version of the visual content can be determined based on the respective GM outputs (or a combination thereof corresponding to the modified version of the visual content itself).

In implementations where the single GM is utilized to process the GM input to generate the GM output, the single GM can be a multimodal GM that is fine-tuned to receive multimodal inputs, such as text-based user input(s), audio-based user input(s), and/or vision-based user input(s), and is fine-tuned to generate multimodal outputs, such as text-based output(s), audio-based output(s), and/or vision-based output(s). Some examples of multimodal GMs that are capable of receiving multimodal inputs and generating multimodal outputs are Bard, Gemini, GPT, etc.

By utilizing the single GM as described herein to generate the modified version of the visual content, one or more technical advantages can be achieved. As one non-limiting example, a single unified user interface is utilized to enable the user to provide simplified user inputs to generate the modified version of the visual content. As a result, the user need not interact with multiple GM(s) that are specific to certain modalities. These techniques are particularly advantageous given the hardware constraints of some client devices. For instance, assume that the client device of the user is a mobile device of a user that has limited display size (e.g., relative to a display of, for example, a laptop or desktop computer). In this instance, the single unified user interface that enables the user to provide the simplified user inputs to generate the modified version of the visual content without the user having to switch between GM applications, between tabs of a web browser application, etc. to generate modified version of the visual content, thereby reducing a quantity of user inputs received at the mobile device and concluding an interaction between the user and the mobile device in a more quick and efficient manner.

In implementations where the multiple GMs are utilized to process the respective GM inputs to generate the respective GM outputs, each of the multiple GMs can be unimodal GMs and/or multimodal GMs that are jointly fine-tuned to receive respective unimodal or multimodal inputs and are jointly fine-tuned to generate the respective outputs. As noted above, some examples of multimodal GMs that are capable of receiving multimodal inputs and generating multimodal outputs are Bard, Gemini, GPT, etc. Further, one example of a unimodal GM that is capable of receiving unimodal inputs and generating audio-based outputs is AudioLM; some examples of a unimodal GM that is capable of receiving unimodal inputs and generated text-based outputs are PaLM, LaMDA, etc.; and some examples of a unimodal GM that is capable of receiving unimodal inputs and generated vision-based outputs are Imagen, Dall-E, Sora, etc. Accordingly, the respective GM inputs (including the user input and optionally other context(s), prompt(s), etc.) can be tailored to the respective multiple GMs to generate the respective GM outputs.

By utilizing the multiple GMs as described herein to generate the modified version of the visual content, one or more technical advantages can be achieved. As one non-limiting example, a single unified user interface is utilized to enable the user to provide simplified user inputs to generate the modified version of the visual content. Even though the multiple GMs are disparate GMs in these implementations, the user only needs to provide a single user input to invoke calls to each of these multiple different GMs, such that the user may not even be aware that multiple GMs are being utilized to generate the modified version of the visual content. These techniques are particularly advantageous given the hardware constraints of some client devices (e.g., constraints of mobile devices as described above).

In various implementations, the GM input can include seed(s) associated with the visual content that was provided by the user. The seed(s) can be a corresponding lower-level representation of the visual content that was provided by the user. For instance, the corresponding lower-level representation of the visual content can be a corresponding embedding in a corresponding embedding space. Accordingly, and in processing the GM input to generate the GM output as described herein, the processor(s) can ensure that the visual content is modified as requested by the user. By utilizing the seed(s) as described herein in modifying the visual content, one or more technical advantages can be achieved. As one non-limiting example, the seed(s) can constrain the extent of how the visual content is modified based on the request included in the user input. As a result, the seed(s) enable the user to modify the visual content quickly and efficiently without requiring that the user re-prompt these GM(s) with detailed instructions regarding what they like about the visual content and/or what they do not like about the visual content. As a result, a length of the user input that is processed to modify the visual content is reduced since the user input and the seed(s) that are determined (which can be a lower-level representation of the visual content) automatically embed this information, thereby conserving computational resources and network resources in modifying the visual content. Further, absent using the seed(s) as described herein in modifying the visual content, any resulting visual content that is subsequently generated may vary greatly from the musical content that was originally provided by the user.

In various implementations, the GM input can include visual content editing instructions that are determined based on the visual content and the request and an indication of bounding box(es) for the visual content. The visual content editing instructions and the bounding box(es) can be determined by the GM (e.g., during an initial pass over the GM prior to a subsequent pass that actually modifies the visual content) or a separate GM (e.g., an explicitation GM as described herein). For instance, the bounding box(es) can effectively mask any portions of the visual content that the user does not desire be modified, and the visual content editing instructions can be utilized to generate modified visual content to replace any content that is contained withing the bounding box(es) and using image generation capabilities and/or video generation capabilities of the GM(s). Accordingly, and in processing the GM input to generate the GM output as described herein, the processor(s) can ensure that the visual content is modified as requested by the user. By utilizing the visual content editing instructions and/or the bounding box(es) as described herein in modifying the visual content, one or more technical advantages can be achieved. As one non-limiting example, the bounding box(es) can constrain portion(s) of the visual content that will modified based on the request included in the user input. Further, the visual content editing instructions can be determined based on the request and/or the portion(s) of the visual content that are to be modified without the user having to explicitly specify the visual content editing instructions that are processed to generate the modified version of the visual content. As a result, the visual content editing instructions and the bounding box(es) enable the user to modify the visual content quickly and efficiently without requiring that the user initially prompt these GM(s) with detailed instructions regarding what they like about the visual content and/or what they do not like about the visual content. As a result, a length of the user input that is processed to modify the visual content is reduced since the user input and the visual content editing instructions and the bounding box(es) that are determined automatically determine this information, thereby conserving computational resources and network resources in modifying the visual content. Further, absent using the visual content editing instructions and the bounding box(es) as described herein in modifying the visual content, any resulting visual content that is subsequently generated may vary greatly from the musical content that was originally provided by the user.

The above description is provided as an overview of some implementations of the present disclosure. Further description of those implementations, and other implementations, are described in more detail below.

### BRIEF DESCRIPTION OF THE DRAWINGS

FIG. 1 depicts a block diagram of an example environment that demonstrates various aspects of the present disclosure, and in which some implementations disclosed herein can be implemented.

FIG. 2 depicts a process flow for utilizing various components from the example environment of FIG. 1, in accordance with various implementations.

FIG. 3 depicts a flowchart illustrating an example method of using generative model(s) (GM(s)) to generate a modified version of visual content, in accordance with various implementations.

FIG. 4A, FIG. 4B, FIG. 4C, FIG. 4D, and FIG. 4E depict various non-limiting examples of using generative model(s) (GM(s)) to generate a modified version of visual content, in accordance with various implementations.

FIG. 5 depicts an example architecture of a computing device, in accordance with various implementations.

### DETAILED DESCRIPTION OF THE DRAWINGS

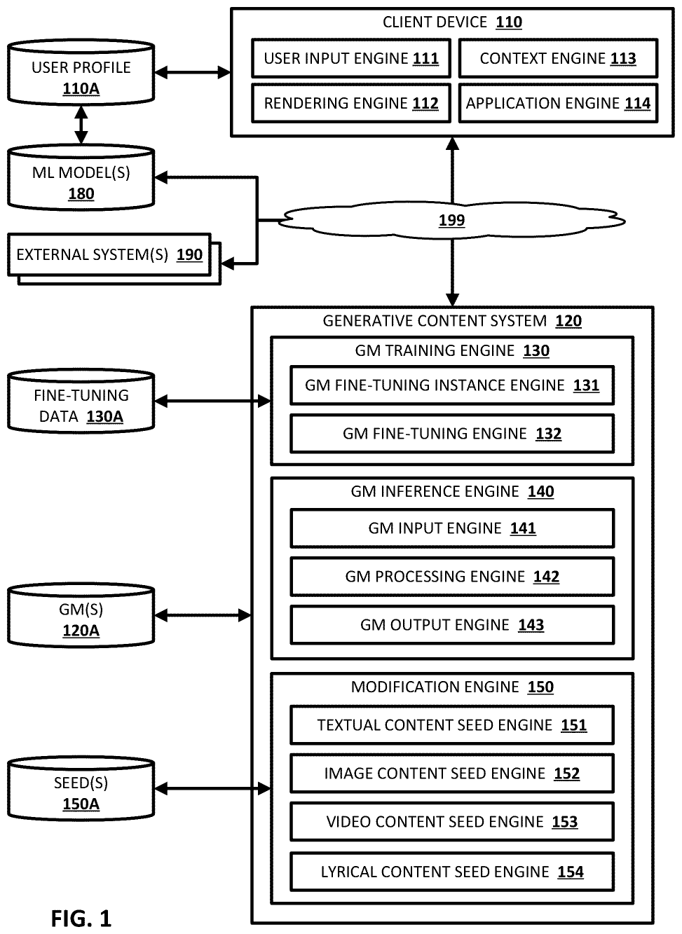

Turning now to FIG. 1, a block diagram of an example environment that demonstrates various aspects of the present disclosure, and in which implementations disclosed herein can be implemented is depicted. The example environment includes a client device 110 and a generative content system 120. In some implementations, all or aspects of the generative content system 120 can be implemented locally at the client device 110. In additional or alternative implementations, all or aspects of the generative content system 120 can be implemented remotely from the client device 110 as depicted in FIG. 1 (e.g., at remote server(s)). In those implementations, the client device 110 and the generative content system 120 can be communicatively coupled with each other via one or more networks 199, such as one or more wired or wireless local area networks (“LANs,” including Wi-Fi®, mesh networks, Bluetooth®, near-field communication, etc.) or wide area networks (“WANs”, including the Internet).

The client device 110 can be, for example, one or more of: a desktop computer, a laptop computer, a tablet, a mobile phone, a computing device of a vehicle (e.g., an in-vehicle communications system, an in-vehicle entertainment system, an in-vehicle navigation system), a standalone interactive speaker (optionally having a display), a smart appliance such as a smart television, and/or a wearable apparatus of the user that includes a computing device (e.g., a watch of the user having a computing device, glasses of the user having a computing device, a virtual or augmented reality computing device). Additional and/or alternative client devices may be provided.

The client device 110 can execute one or more software applications, via application engine 114, through which touch inputs and/or other user inputs can be submitted and/or content that is responsive to the touch inputs and/or the other user inputs can be rendered (e.g., audibly and/or visually). The application engine 114 can execute one or more software applications that are separate from an operating system of the client device 110 (e.g., one installed “on top” of the operating system)—or can alternatively be implemented directly by the operating system of the client device 110. For example, the application engine 114 can execute a web browser, generative content application, or automated assistant installed on top of the operating system of the client device 110. As another example, the application engine 114 can execute a web browser software application, a generative content software application, or automated assistant software application that is integrated as part of the operating system of the client device 110. The application engine 114 (and the one or more software applications executed by the application engine 114) can interact with or otherwise provide access to (e.g., as a front-end) the generative content system 120 via an application programming interface (API).

In various implementations, the client device 110 can include a user input engine 111 that is configured to detect user input provided by a user of the client device 110 using one or more user interface input devices. For example, the client device 110 can be equipped with one or more microphones that capture audio data, such as audio data corresponding to spoken utterances of the user or other sounds in an environment of the client device 110. Additionally, or alternatively, the client device 110 can be equipped with one or more vision components that are configured to capture vision data corresponding to images and/or movements (e.g., gestures) detected in a field of view of one or more of the vision components. Additionally, or alternatively, the client device 110 can be equipped with one or more touch sensitive components (e.g., a keyboard and mouse, a stylus, a touch screen, a touch panel, one or more hardware buttons, etc.) that are configured to capture signal(s) corresponding to typed and/or touch inputs directed to the client device 110. Additionally, or alternatively, the client device 110 can be equipped with one or more interfaces that are configured to receive content (e.g., document(s), image(s), video(s), audio, etc.) provided by the user of the client device 110.

In some versions of those implementations, the client device 110 can utilize one or more machine learning (ML) model(s) stored in ML model(s) database 180 to process the user input. For example, the user input received at the client device 110 may be a spoken utterance. In these examples, the user input engine 111 can process, using automatic speech recognition (ASR) model(s) stored in the ML model(s) database 180 (e.g., a recurrent neural network (RNN) model, a transformer model, and/or any other type of ML model capable of performing ASR), audio data that capture the spoken utterance and that is generated by microphone(s) of the client device 110 to generate ASR output. The ASR output can include, for example, speech hypotheses (e.g., term hypotheses and/or transcription hypotheses) that are predicted to correspond to the spoken utterance captured in the audio data, one or more corresponding predicted values (e.g., probabilities, log likelihoods, and/or other values) for each of the speech hypotheses, a plurality of phonemes that are predicted to correspond to the spoken utterance captured in the audio data, one or more corresponding predicted values (e.g., probabilities, log likelihoods, and/or other values) for each of the plurality of phonemes, and/or other ASR output. In these implementations, the user input engine 111 can select one or more of the speech hypotheses as recognized text that corresponds to the spoken utterance (e.g., based on the corresponding predicted values for each of the speech hypotheses), such as when the user input engine 111 utilizes an end-to-end ASR model. In other implementations, the user input engine 111 can select one or more of the predicted phonemes (e.g., based on the corresponding predicted values for each of the predicted phonemes), and determine recognized text that corresponds to the spoken utterance based on the one or more predicted phonemes that are selected, such as when the user input engine 111 utilizes an ASR model that is not end-to-end. In these implementations, the user input engine 111 can optionally employ additional mechanisms (e.g., a directed acyclic graph) to determine the recognized text that corresponds to the spoken utterance based on the one or more predicted phonemes that are selected.

In various implementations, the client device 110 can include a rendering engine 112 that is configured to render content for audible and/or visual presentation to a user of the client device 110 using one or more user interface output devices. For example, the client device 110 can be equipped with speaker(s) that enable the content to be rendered as audible content via the client device 110. Additionally, or alternatively, the client device 110 can be equipped with a display or projector that enables the content to be rendered as textual content, and optionally along with other visual content (e.g., image(s), video(s), etc.), via the client device 110.

In some versions of those implementations, the client device 110 can utilize one or more of the ML model(s) stored in the ML model(s) database 180 to process content described herein. For example, and as noted above, the content can be audibly rendered as audible content via the speaker(s) of the client device 110. In these examples, the rendering engine 112 can process, using text-to-speech (TTS) model(s) stored in the ML model(s) database 180, content (e.g., lyrical or other audible content generated using the generative content system 120) to generate synthesized speech audio data that includes computer-generated synthesized speech capturing the lyrical or the other audible content. In implementations where the rendering engine 112 utilizes the TTS model(s) to process the content, the rendering engine 112 can generate the synthesized speech using a particular set of one or more prosodic properties (e.g., that define a tone, pitch rhythm, speed, etc. of the computer-generated synthesized speech) and/or using a particular voice embedding to reflect different personas and/or speaking styles, such as a particular set of one or more prosodic properties associated with the user of the client device 110 and/or a voice embedding associated with the user of the client device 110.

Notably, although the ML model(s) stored in the ML model(s) database 180 are described above as being implemented locally by the client device 110, it should be understood that is for the sake of example and is not meant to be limiting. For instance, the audio data that captures the spoken utterance can additionally, or alternatively, be streamed to the generative content system 120, and the generative content system 120 can utilize the ASR model(s) stored in the ML model(s) database 180 (or separate cloud-based ASR model(s)) to generate the ASR output. Also, for instance, the summary of the content can be additionally, or alternatively, be processed by the generative content system 120 utilizing the TTS model(s) stored in the ML models) database 180 (or separate cloud-based TTS model(s)) to generate the synthesized speech audio data, and the synthesized speech audio data can be streamed to the client device 110 (or an additional client device of the user) to cause the synthesized speech audio date to audibly rendered for presentation to the user of the client device 110.

In various implementations, the client device 110 can include a context engine 113 that is configured to determine a client device context (e.g., current or recent context) of the client device 110 and/or a user context of a user of the client device 110 (or an active user of the client device 110 when the client device 110 is associated with multiple users). In some of those implementations, the context engine 113 can determine a context based on data stored in user profile database 110A. The data stored in the user profile database 110A can include, for example, user interaction data that characterizes current or recent interaction(s) of the client device 110 and/or a user of the client device 110, location data that characterizes a current or recent location(s) of the client device 110 and/or a geographical region associated with a user of the client device 110, user attribute data that characterizes one or more attributes of a user of the client device 110, user preference data that characterizes one or more preferences of a user of the client device 110, and/or any other data accessible to the context engine 113 via the user profile database 110A or otherwise.

For example, the context engine 113 can determine a current context based on a current state of a dialog session (e.g., considering one or more recent user inputs provided by a user during the dialog session) and/or a current location of the client device 110. For instance, the context engine 113 can determine a current context of “visitor looking for upcoming events in Louisville, Kentucky” based on a recently issued query and an anticipated future location of the client device 110 (e.g., based on recently booked hotel accommodations). As another example, the context engine 113 can determine a current context based on which software application is active in the foreground of the client device 110, a current or recent state of the active software application, and/or content currently or recently rendered by the active software application. A context determined by the context engine 113 can be utilized, for example, in supplementing or rewriting user inputs that are received at the client device 110, in generating an implied user input (e.g., an implied query or prompt formulated independent of any explicit user input provided by a user of the client device 110), and/or in determining to submit an implied user input and/or to render result(s) (e.g., the content) for an implied user input.

Further, the client device 110 and/or the generative content system 120 can include one or more memories for storage of data and/or software applications, one or more processors for accessing data and executing the software applications, and/or other components that facilitate communication over one or more of the networks 199. In some implementations, one or more of the software applications can be installed locally at the client device 110, whereas in other implementations one or more of the software applications can be hosted remotely (e.g., by one or more servers) and can be accessible by the client device 110 over one or more of the networks 199.

Although aspects of FIG. 1 are illustrated or described with respect to a single client device having a single user, it should be understood that is for the sake of example and is not meant to be limiting. For example, one or more additional client devices of a user and/or of additional user(s) can also implement the techniques described herein. For instance, the client device 110, the one or more additional client devices, and/or any other computing devices of a user can form an ecosystem of devices that can employ techniques described herein. These additional client devices and/or computing devices may be in communication with the client device 110 (e.g., over the network(s) 199). As another example, a given client device can be utilized by multiple users in a shared setting (e.g., a group of users, a household, a workplace, a hotel, etc.).

The generative content system 120 is illustrated in FIG. 1 as including a generative model (GM) training engine 130, a GM inference engine 140, and a modification engine 150. Some of these engines can be combined and/or omitted in various implementations. Further, these engines can include various sub-engines. For instance, the GM training engine 130 is illustrated in FIG. 1 as including a GM fine-tuning instance engine 131 and a GM fine-tuning engine 132. Further, the GM inference engine 140 is illustrated in FIG. 1 as including a GM input engine 141, a GM processing engine 142, and a GM output engine 143. Moreover, the modification engine 150 is illustrated in FIG. 1 as including a textual content seed engine 151, an image content seed engine 152, a video content seed engine 153, and an audio content seed engine 154. Similarly, some of these sub-engines can be combined and/or omitted in various implementations. Accordingly, it should be understood that the various engines and sub-engines of the generative content system 120 illustrated in FIG. 1 are not meant to be limiting.

Further, the generative content system 120 is illustrated in FIG. 1 as interfacing with various databases, such as GM(s) database 120A, fine-tuning data database 130A, and seed(s) database 150A. Although particular engines and/or sub-engines are depicted as having access to particular databases, it should be understood that is for the sake of example and is not meant to be limiting. For instance, in some implementations, each of the various engines and/or sub-engines of the generative content system 120 may have access to each of the various databases. Further, some of these databases can be combined and/or omitted in various implementations. Accordingly, it should be understood that the various databases interfacing with the generative content system 120 illustrated in FIG. 1 are not meant to be limiting.

Moreover, the generative content system 120 is illustrated in FIG. 1 as interfacing with other system(s), such as external system(s) 190. The external system(s) can include, for example, search system(s) (e.g., text-based search system(s), image-based search system(s), video-based search system(s), etc.) and/or other generative system(s) (other text-based generative system(s), other image-based generative system(s), other video-based generative system(s), other audio-based generative system(s), etc.). In some implementations, the external system(s) 190 are first-party system(s), whereas in other implementations, the external system(s) 190 are third-party system(s). As used herein, the term “first-party” or “first-party entity” refers to an entity that controls, develops, and/or maintains the generative content system 120, whereas the term “third-party” or “third-party entity” refers to an entity that is distinct from the entity that controls, develops, and/or maintains the generative content system 120. Th client device 110 and/or the generative content system can interact with the external system(s) 190 via API(s).

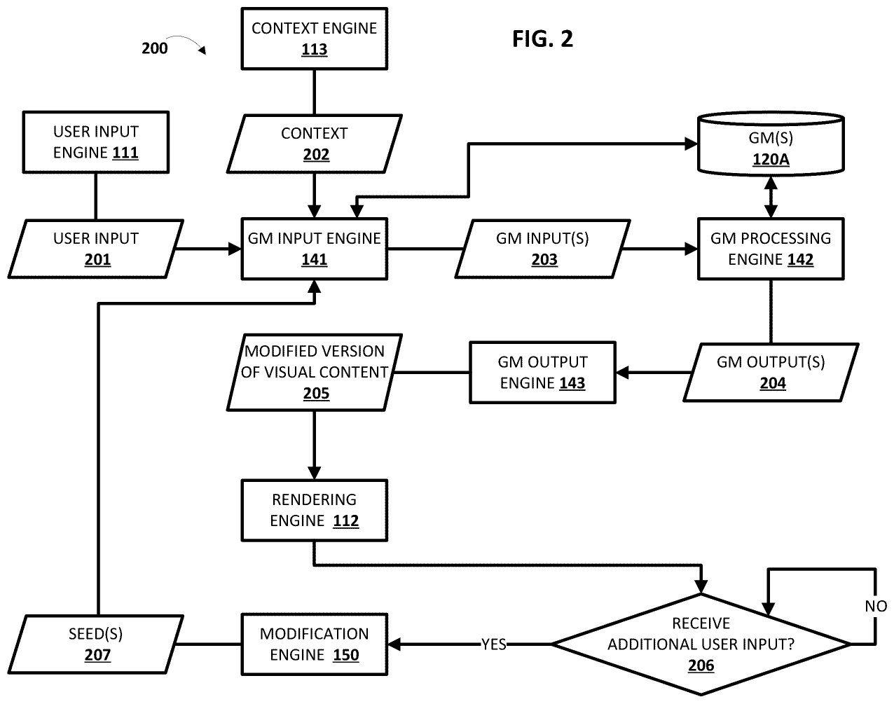

As described in more detail herein (e.g., with respect to FIGS. 2, 3, and 4A-4E), the generative content system 120 can be utilized to generate a modified version of visual content provided by a user of the client device 110 and based on a request provided by the user of the client device 110 along with the visual content. The visual content can include, for example, image content, video content, and/or other forms of visual content. Further, the request to modify the visual content can include, for example, a request to modify portion(s) of the visual content, animate portion(s) of the visual content, add textual content that is related to the visual content, add audible content that is related to the image content, and/or other requests provided by the user of the client device 110. In some implementations, the modified version of the visual content can be generated using a single call to a single GM. In these implementations, the single GM can be fine-tuned to generate the modified version of the visual content. In additional or alternative implementations, the modified version of the visual content can be generated using respective calls to multiple GMs, but through a single unified interface. In these implementations, each of the multiple GMs can be jointly fine-tuned in an end-to-end manner to generate respective portions of the modified version of the musical content. In various implementations, the generative content system 120 can be utilized to iteratively refine the modified version of the visual content based on additional request(s) provided by the user of the client device 110. In various implementations, and in generating the modified version of the visual content and/or in iteratively refining the modified version of the visual content, the generative content system 120 can determine seed(s) for the visual content or portion(s) of the visual content and utilize the seed(s) and the additional user input for further processing by the GM(s) to generate the modified version of the visual content and/or subsequent refinements to the modified version of the visual content. By using the seed(s) as described herein, the visual content can be efficiently modified as specified by the additional user input while maintaining certain aspects of the musical content. Absent utilization of the seed(s) as described herein, any resulting visual content that is subsequently generated may vary greatly from the visual content that was originally provided by the user, thereby undermining utilization of the GM(s) in generating the modified version of the visual content.

As indicated above, in implementations where the modified version of the visual content is generated using the single call to the single GM, the single GM can be fine-tuned to generate the modified version of the visual content. The single GM can be stored in the GM model(s) database 120A, and can include any GM (e.g., Bard, Gemini, GPT, and/or any other GM, such as any other GM that is encoder-only based, decoder-only based, sequence-to-sequence based and that optionally includes an attention mechanism or other memory). Notably, the GM(s) stored in the GM(s) database 120A can include billions of weights and/or parameters that are learned through initially training the GM on enormous amounts of diverse data. This enables these GM(s) to generate GM output as a probability distribution over a sequence of tokens as described herein. Further, in implementations where the modified version of the visual content is generated using the single call to the single GM, the single GM can be a multimodal GM that is fine-tuned to be capable of processing text-based user inputs (e.g., typed user inputs provided by the user of the client device 110), audio-based user inputs (e.g., spoken user inputs provided by the user of the client device 110), and/or vision-based user inputs (e.g., image(s) and/or video(s) provided by the user of the client device 110) to generate text-based content (e.g., text corresponding to the lyrical content as described herein and/or text corresponding to the music composition content, such as music notes, as described herein), audio-based content (e.g., audio data corresponding to the lyrical content as described herein and/or audio data corresponding to the music composition content described herein), and/or visual-based content (e.g., image(s) and/or video(s) associated with the music content as described herein).

In fine-tuning the single GM, the GM fine-tuning instance engine 131 can access the fine-tuning data database 130A to obtain a plurality of fine-tuning instances. Each of the plurality of fine-tuning instances can include corresponding fine-tuning visual content, corresponding fine-tuning request(s) to modify the corresponding fine-tuning visual content, and corresponding fine-tuning modified version(s) of the corresponding fine-tuning visual content. Further, in fine-tuning the single GM based on a given fine-tuning instance, of the plurality of fine-tuning instances, the GM fine-tuning engine 132 can process the corresponding fine-tuning visual content and the corresponding fine-tuning request(s) to modify the corresponding fine-tuning visual content to generate predicted modified version(s) of the corresponding fine-tuning visual content. In some implementations, the GM fine-tuning engine 132 can compare the predicted modified version(s) of the corresponding fine-tuning visual content to the corresponding fine-tuning lyrical content for the given fine-tuning instance and the predicted music composition content to the corresponding fine-tuning modified version(s) of the corresponding fine-tuning visual content for the given fine-tuning instance to generate one or more losses. Moreover, the GM fine-tuning engine 132 can update the single GM based on one or more of the losses. Although particular learning techniques for fine-tuning the single GM are described above (e.g., supervised fine-tuning (SFT) techniques) it should be understood that is for the sake of example and is not meant to be limiting.

For instance, the GM fine-tuning engine 132 can additionally, or alternatively, utilize a reinforcement learning from human feedback (RLHF) technique where the predicted modified version(s) of the corresponding fine-tuning visual content is/are provided for presentation to a developer associated with the generative content system 120 (or another human user) and the developer (or the other human user) can provide feedback with respect to the predicted modified version(s) of the corresponding fine-tuning visual content given the corresponding fine-tuning visual content and corresponding fine-tuning request(s) to modify the corresponding fine-tuning visual content that was processed using the single GM. For instance, the feedback can relate to how responsive the predicted modified version(s) of the corresponding fine-tuning visual content is/are, etc. Based on the feedback, a reward model can be utilized to generate a reward (e.g., positive reward or negative reward) that can be utilized to update the single GM. However, it should be noted that techniques that require involvement of the developer (or other users, such as Mechanical Turks) consume additional computational and pecuniary resources.

As also indicated above, in implementations where the musical content is generated using the respective calls to the multiple GMs, each of the multiple GMs can be jointly fine-tuned in an end-to-end manner to generate the respective portions of the modified version of the visual content. Each of the multiple GMs can be stored in the GM model(s) database 120A, and can include any GM (e.g., Bard, Gemini, GPT, and/or any other GM, such as any other GM that is encoder-only based, decoder-only based, sequence-to-sequence based and that optionally includes an attention mechanism or other memory). Further, in implementations where the musical content is generated using the respective calls to the multiple GMs, each of the GMs may have respective modalities. For instance, a first GM can be fine-tuned to be capable of processing text-based user inputs (e.g., typed user inputs provided by the user of the client device 110), audio-based user inputs (e.g., spoken user inputs provided by the user of the client device 110), and/or vision-based user inputs (e.g., image(s) and/or video(s) provided by the user of the client device 110) to generate text-based content (e.g., text corresponding to the lyrical content as described herein and/or text corresponding to the music composition content, such as music notes, as described herein). Further, a second GM can be fine-tuned to be capable of processing the text-based user inputs, the audio-based user inputs, and/or the vision-based user inputs to generate audio-based content (e.g., audio data corresponding to the lyrical content as described herein and/or audio data corresponding to the music composition content described herein). Moreover, a third GM can be fine-tuned to be capable of processing the text-based user inputs, the audio-based user inputs, and/or the vision-based user inputs to generate visual-based content (e.g., image(s) and/or video(s) associated with the music content as described herein).

In jointly fine-tuning the multiple GMs in an end-to-end manner, the GM fine-tuning instance engine 131 can access the fine-tuning data database 130A to obtain a plurality of respective fine-tuning instances for each of the multiple GMs. Each of the plurality of fine-tuning instances can include corresponding fine-tuning visual content, corresponding fine-tuning request(s) to modify the corresponding fine-tuning visual content, and portions(s) of the corresponding fine-tuning modified version(s) of the corresponding fine-tuning visual content that are to be generated by the respective GM, if any. Further, the GM fine-tuning engine 132 can cause each of the respective GMs to process the corresponding the plurality of fine-tuning instances using the same or similar SFT, RLHF, and/or other fine-tuning techniques to update each of the respective GMs. Notably, any losses that are generated using the SFT technique and/or any rewards that are generated using the RLHF technique can be shared among each of the respective GMs, and optionally weighted (hence the phrase jointly fine-tuning).

Turning now to FIG. 2, a process flow for utilizing various components from the example environment of FIG. 1 is depicted. For the sake of example, assume that the user of the client device 110 provides user input 201 and the user input 201 is detected via the user input engine 111. For instance, assume that the user input 201 includes an image of a flyer that the user made for a fundraiser for an animal shelter and a request to modify the image of the flyer of “can you add some puppies of the same breed next to the image of the dog on the flyer”. In this example, the GM input engine 141 can process the user input 201 to generate GM input(s) 203. Notably, in generating the GM input(s) 203, the GM input engine 141 can utilize an explicitation GM (e.g., stored in the GM(s) database 120A). The explicitation GM can be one form of a GM that processes the user input 201 (and optionally context 202 determined by the context engine 113 of the client device 110) to generate the GM input(s) 203. The GM input(s) 203 can then be provided to the GM processing engine 142 to generate GM output(s) 204. Put another way, the GM input engine 141 can utilize explicitation GM to process the raw user input 201 and put it in a structured form that is more suitable for processing by the GM processing engine 142. Further, the GM input engine 141 can utilize explicitation GM to incorporate the context 202 into the GM input(s) and optionally any other dynamic prompts to aid the GM processing engine 142 in generating the GM output(s) 204. For instance, and based on the user input 201 being the image of the flyer and the request of “can you add some puppies of the same breed next to the image of the dog on the flyer”, the context 202 can include a breed of the dog in the flyer (e.g., obtained via a call to one of the external system(s) 190, such as the Internet via Google Lens), an indication that the user is employed at the animal shelter based on user profile data stored in the user profile database 110A, and/or other context. Further, and based on the request included in the user input 201 being “can you add some puppies of the same breed next to the image of the dog on the flyer”, a dynamic prompt can include, for instance, “add puppies of the same breed to the flyer, they are smaller than the dog included in the flyer, and they should be cute and fluffy” or the like.

In some implementations, and in generating the GM input(s) 203 when the visual content is image content provided by the user, the GM input engine 141 can utilize raw pixels of the visual content or an array of pixel values representing the raw pixels of the visual content as part of the GM input(s) 203. Continuing with the above example where the user input 201 includes the image of the flyer and the request of “can you add some puppies of the same breed next to the image of the dog on the flyer”, the raw pixels of the image of the flyer can be included in the GM input(s) 203 or the array of pixel values representing the raw pixels of the image of the flyer can be included in the GM input(s) 203. In some implementations, and in generating the GM input(s) 203 when the visual content is video content provided by the user, the GM input engine 141 can utilize a sequence of raw pixels of the visual content or a sequence of arrays of pixel values representing the raw pixels of the visual content as part of the GM input(s) 203.

In additional or alternative implementations, and in generating the GM input(s) 203, the GM input engine 141 can further cause the user input 201 to be provided to the modification engine 150. The modification engine 150 can determine seed(s) 207 for the visual content that was included in the user input 201 and based on the request that was included in the user input 201, and optionally storing the seed(s) 207 in the seed(s) database 150A for future usage in making any further modification(s) to the visual content. Continuing with the above example where the user input 201 includes the image of the flyer and the request of “can you add some puppies of the same breed next to the image of the dog on the flyer”, the textual content seed engine 151 can determine seed(s) 207 for any textual content included in the flyer (e.g., the name of the animal shelter, the date and time of the fundraiser, the location of the fundraiser, an arrangement of the textual content, and/or any other textual information that is associated with the fundraiser) and the image content seed engine 152 can determine seed(s) 207 for any image content included in the flyer (e.g., characterizing animals or other objects depicted in the flyer, characterizing an arrangement and/or orientation of the animals or other objects depicted in the flyer, etc.). Notably, the seed(s) 207 can be a corresponding lower-level representation of the content included in the user input 201. For instance, the corresponding lower-level representation of the content can be a corresponding embedding in a corresponding learned embedding space. Thus, in these implementations, the GM input engine 141 can cause the explicitation GM to include the seed(s) 207 as part of the GM input(s) 203.

In some versions of those implementations, different modalities may be associated with separate corresponding learned embedding spaces. Continuing with the above example, the seed(s) 207 for any textual content included in the flyer may be mapped to a learned embedding space that is specific textual content, and the seed(s) for any image content included in the flyer may be mapped to a separate, learned embedding space that is specific to image content. In additional or alternative implementations, multiple different modalities may be associated with a given corresponding learned embedding space. Continuing with the above example, the seed(s) 207 for any textual content included in the flyer and the seed(s) for any image content included in the flyer may be mapped to given learned embedding space for both textual content and image content.

Although the above examples are described with respect to textual content and image content, it should be noted that is for the sake of example and is not meant to be limiting. Rather, it should be understood that other modalities (e.g., video modality, audio modality, and/or other modalities) are also contemplated herein. In implementations where the visual content includes video content (e.g., in addition to or in lieu of the textual content and/or the image content described above), the GM input(s) 203 can include, for example, a sequence of raw pixels of the visual content or a sequence of arrays of pixel values representing the raw pixels of the visual content as part of the GM input(s) 203 as noted above. Additionally, or alternatively, the video content seed engine 153 can determine seed(s) 207 for any video content (e.g., characterizing objects or entities included in the video content, characterizing an arrangement and/or orientation of objects or entities included in the video content, characterizing motion of objects or entities included in the video content, etc.). Further, in implementations where the visual content is accompanied by audio content (e.g., in addition to or in lieu of the textual content and/or the image content described above, and/or any video content), the GM input(s) 203 can include, for example, a raw audio data, representations of the raw audio data (e.g., an audio waveform), features of the raw audio data (e.g., phonemes, mel-cepstral frequency coefficients (MFCCs), etc.), etc. as part of the GM input(s) 203. Additionally, or alternatively, the audio content seed engine 154 can determine seed(s) 207 for any audio content (e.g., characterizing voices included in the audio content such as a voice embedding, characterizing an indication of speakers in the audio content, characterizing prosodic properties of the audio data, etc.).

In additional or alternative implementations, and in generating the GM input(s) 203, the GM input engine 141 can further utilize the explicitation GM to determine mask(s) for the visual content. For instance, the explicitation GM can be utilized to determine visual content modification instructions and determine the mask(s) for the visual content. Continuing with the above example where the user input 201 includes the image of the flyer and the request of “can you add some puppies of the same breed next to the image of the dog on the flyer”, the explicitation GM 150 identify the dog in the flyer and can mask additional portion(s) of the flyer that do not include the dog while leaving portion(s) of the flyer that do include the dog unmasked (e.g., similar to a bounding box). Similarly, in implementations where the visual content is video content, the explicitation GM can be utilized to determine visual content modification instructions and determine the mask(s) for the visual content across a sequence of video frames. Further, in implementations where the visual content is accompanied by audio content, the explicitation GM can be utilized to determine audio content modification instructions and determine the mask(s) for the audio content while leaving other portion(s) of the audio content unmasked. Thus, in these implementations, the GM input engine 141 can cause various portions of the visual content (or other portions of content that accompany the visual content) to be masked as part of the GM input(s) 203.

In implementations where a single GM is utilized to generate the modified version of the visual content, the GM input(s) 203 may only include a single GM input. Further, in these implementations, the GM processing engine 142 can process, using the single GM, the GM input(s) 203 to generate the GM output(s) 204. In implementations where multiple GMs are utilized to generate the musical content, the GM input(s) 203 may include a respective GM input for each of the multiple GMs, where each of the respective GM inputs may vary in that the context 202 or dynamic prompt(s) may vary for each of the GMs. Further, in these implementations, the GM processing engine 142 can process, using each of the multiple GMs, the respective one of the GM input(s) 203 to generate the GM output(s) 204 via the respective GMs. Moreover, the GM output engine 143 can employ various decoding techniques to determine a modified version of the visual content 205.

Continuing with the above example where the user input 201 includes the image of the flyer and the request of “can you add some puppies of the same breed next to the image of the dog on the flyer”, assume that the GM input(s) 203 include the seed(s) 207 in the learned embedding space(s) as noted above. In this example, and based on the request included in the user input 201, the GM processing engine 142 can move the seed(s) 207 associated with portion(s) of the flyer that include the dog in the learned embedding space(s) to determine updated seed(s) that reflect the dog with puppies of the same breed next to the dog. The updated seed(s) can then be processed, using image generation capabilities of the GM(s), to modify the portion of the flyer that includes the dog to also include the puppies of the same breed next to the dog. Notably, other of the seed(s) 207 associated with other portion(s) of the flyer and/or any text included in the flyer may remain unchanged. As a result, and based on processing the GM output(s) 204, the GM output engine 143 can determine the modified version of the visual content 205. Additionally, or alternatively, assume that the GM input(s) 203 include the mask(s) as noted above. In this example, and based on the request included in the user input 201, the GM processing engine 142 can process the image editing instructions associated with the unmasked portion(s) of the flyer that include the dog to replace the image of the dog with the image of the dog and the puppies of the same breed. As a result, and based on processing the GM output(s) 204, the GM output engine 143 can determine the modified version of the visual content 205.

Although the above example is described with respect to modifying only the image content of the flyer, it should be understood that is for the sake of illustrating various techniques described herein and is not meant to be limiting. For example, the same or similar techniques can be utilized to generate textual content for the flyer and/or modify existing textual content of the flyer using natural language understanding and generation capabilities of the GM(s). Further, the same or similar techniques can be utilized to generate video content for the flyer and/or modify existing video content associated with the flyer using video understanding and generation capabilities of the GM(s). Moreover, the same or similar techniques can be utilized to generate audio content for the flyer and/or modify existing audio content associated with the flyer using audio understanding and generation capabilities of the GM(s).

In various implementations, and as indicated at block 206, the generative content system may receive additional user input to further modify the visual content. If no additional user input is received, then the generative content system 120 may wait for additional user input to be received at block 206. However, if additional user input is received, then the modification engine 150 can determine further seed(s) to be utilized in generating the further version modified version of the visual content. Continuing with the above example where the user input 201 includes the image of the flyer and the request of “can you add some puppies of the same breed next to the image of the dog on the flyer”, further assume that the user of the client device 110 provides additional user input animate one or more aspects of the flyer, to generate a short video based on the flyer, to generate audio content to accompany the flyer, and/or otherwise further modify the flyer that was originally provided by the user. In this example, the additional user input can cause the generative content system to generate the further seed(s) to ensure that aspects that the user wishes to remain the same in the modified version of the visual content remain the same, while other aspects that the user wishes to further modify in the modified version of the visual content are, in fact, modified. Additionally, or alternatively, raw inputs (or representations of raw input) and/or masking technique(s) can be utilized as described above.

Although particular visual content and user inputs to modify the visual content is described above, it should be understood that is for the sake of example and is not meant to be limiting. Rather, it should be understood that the visual content may depend on what the user uploads to the generative content system 120 and/or caused to be previously generated using the generative content system 120. Further, it should be understood that the user inputs to modify the visual content may depend on how specifically the user desires to modify the visual content. While how specifically the user desires to modify the visual content may be subjective, the generative content system 120 described herein objectively enables such modifications to be performed in a more a computationally efficient manner. For instance, the generative content system 120 described herein enables such modifications to be performed through a single, unified user interface that is capable of receiving user inputs is different modalities and generating outputs in different modalities, thereby objectively reducing a quantity of user inputs across disparate interfaces and/or applications. Other technical advantages are described herein.

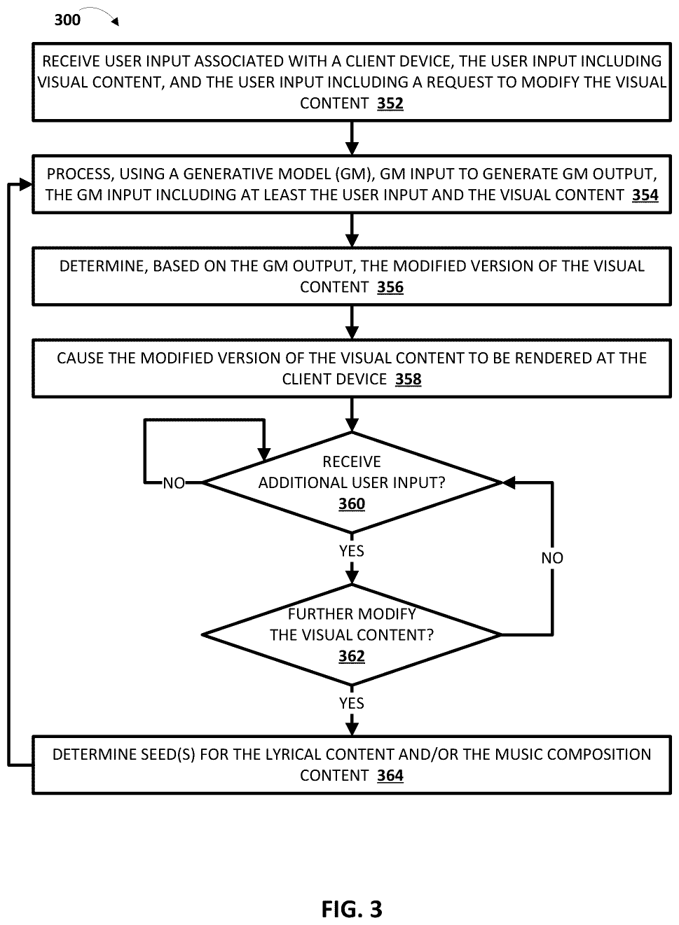

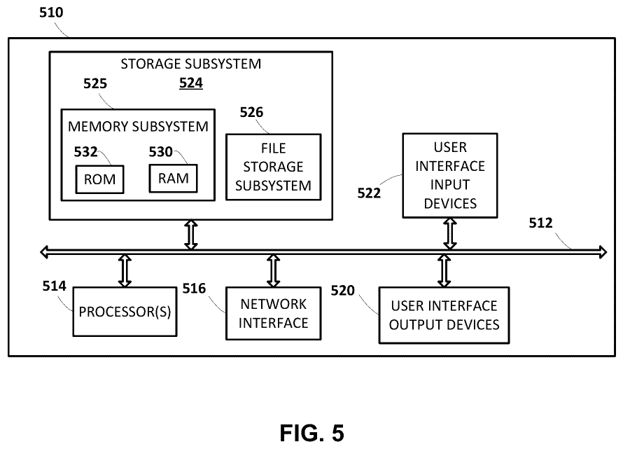

Turning now to FIG. 3, a flowchart illustrating an example method 300 of using generative model(s) (GM(s)) to generate a modified version of visual content is depicted. For convenience, the operations of the method 300 are described with reference to a system that performs the operations. This system of the method 300 includes one or more processors, memory, and/or other component(s) of computing device(s) (e.g., client device 110 of FIG. 1, generative content system 120 of FIG. 1, computing device 510 of FIG. 5, one or more servers, and/or other computing devices). Moreover, while operations of the method 300 are shown in a particular order, this is not meant to be limiting. One or more operations may be reordered, omitted, and/or added.

At block 352, the system receives user input associated with a client device of a user, the user input including visual content, and the user input including a request to modify the visual content. The user input can be received via typed input, spoken input, touch input, etc. In some implementations, the visual content can be generative content that is generated in a previous turn of a dialog between the system and the user and/or that is generated via a separate system (e.g., one of the external system(s) 190) and uploaded to the system. In other implementations, the visual content can be non-generative content that is uploaded to the system.

At block 354, the system processes, using a generative model (GM), GM input to generate GM output, the GM input including at least the user input and the visual content. For example, the system can generate the GM input (e.g., as described with respect to the GM input processing engine 141 of FIGS. 1 and 2), and can process the GM input, using the GM, to generate the GM output (e.g., as described with respect to the GM processing engine 142 of FIGS. 1 and 2).

At block 356, the system determines, based on the GM output, the modified version of the visual content. For example, the system can determine the modified version of the visual content based on the GM output as described herein (e.g., as described with respect to the GM processing engine 142 and the GM output engine 143 of FIGS. 1 and 2).

At block 358, the system causes the modified version of the visual content to be rendered at the client device. For example, the system can cause the modified version of the visual content to be visually rendered via a display of the client device. Further, if there is any audio data that accompanies the modified version of the visual content, the system can cause the audio data that accompanies the modified version of the visual content to be audibly rendered via speaker(s) of the client device.

At block 360, the system determines whether additional user input has been received. The additional user input can be received via typed input, spoken input, touch input, etc. If, at an iteration of block 360, the system determines that no additional user input has been received, then the system can continue monitoring for additional user input at block 360.

If, at an iteration of block 360, the system determines that additional user input has been received, then the system proceeds to block 362. At block 362, the system determines whether the additional user input was provided to further modify the visual content. If, at an iteration of block 362, the system determines that the additional user input was not provided to further modify the visual content, then the system returns to block 360. However, it should be noted that the system can still respond to the user if the additional user input was not provided to further modify the visual content. Nonetheless, the system can still continue monitoring for additional user inputs that are provided to further modify the visual content such that it persists across a dialog session between the user and the system, and such that it persists across multiple dialog sessions between the user and the system.

If, at an iteration of block 362, the system determines that the additional user input was provided to further modify the visual content, then the system proceeds to block 364. At block 364, the system determines one or more seeds for the modified version of the visual content. For example, the system can determine the one or more seeds as described herein (e.g., with respect to the modification engine 150 of FIGS. 1 and 2). It should be understood that the seed(s) determined at block 364 can vary based on how the additional user input requests that the visual content be further modified. Additionally, or alternatively, the system can determine mask(s) for portion(s) of the visual content (e.g., as described with respect to FIG. 2). The system returns to block 354 and continues with the method 300.

However, in returning to block 354 and continuing with the method 300, the system can process additional GM input to generate additional GM output. The additional GM input includes at least the seed(s) (or mask(s)) determined at block 364 and the additional user input. Accordingly, by continuing with the iteration of the method 300, and through utilization of the seed(s) (or the mask(s)), a further modified version of the visual content should retain aspects of the previously rendered modified version of the visual content, but also include modifications based on how the additional user input requests that the visual content be further modified.

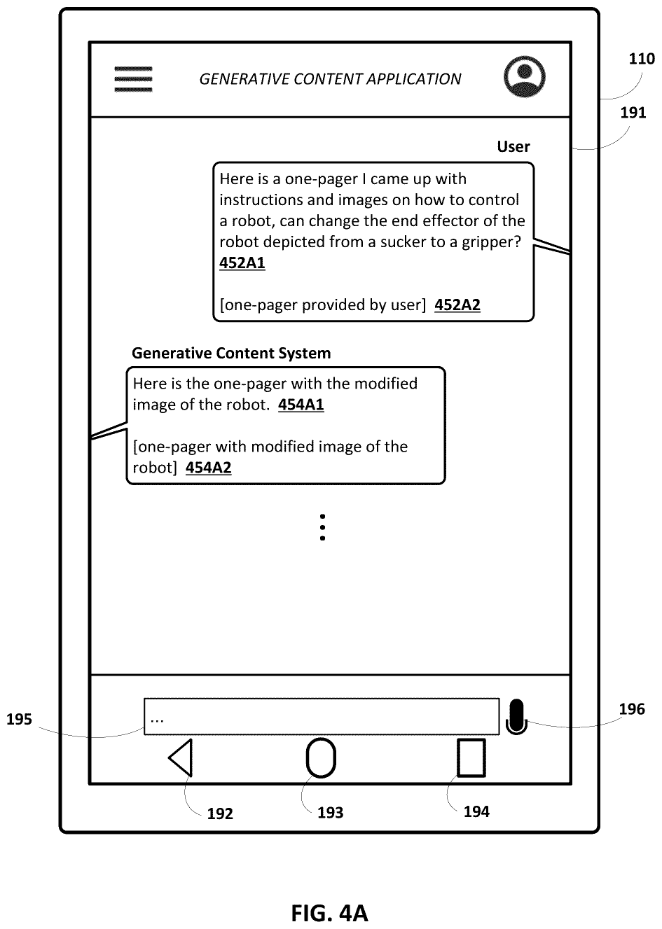

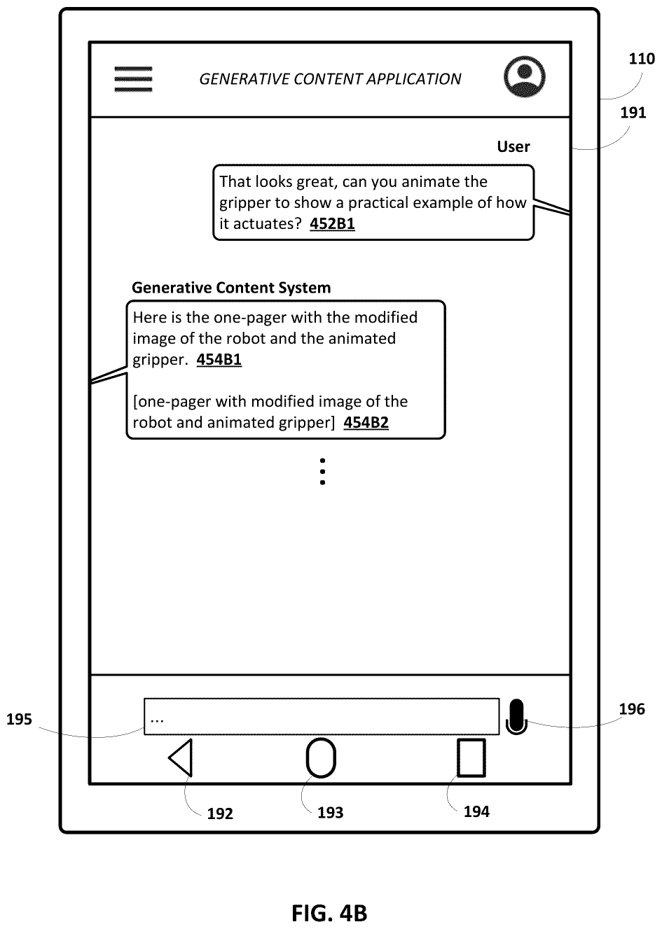

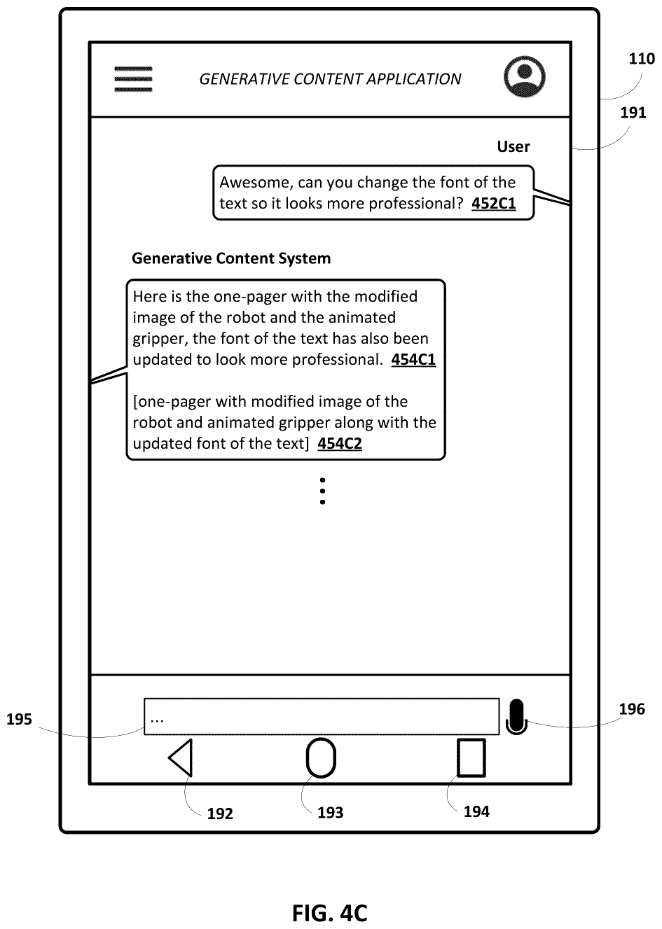

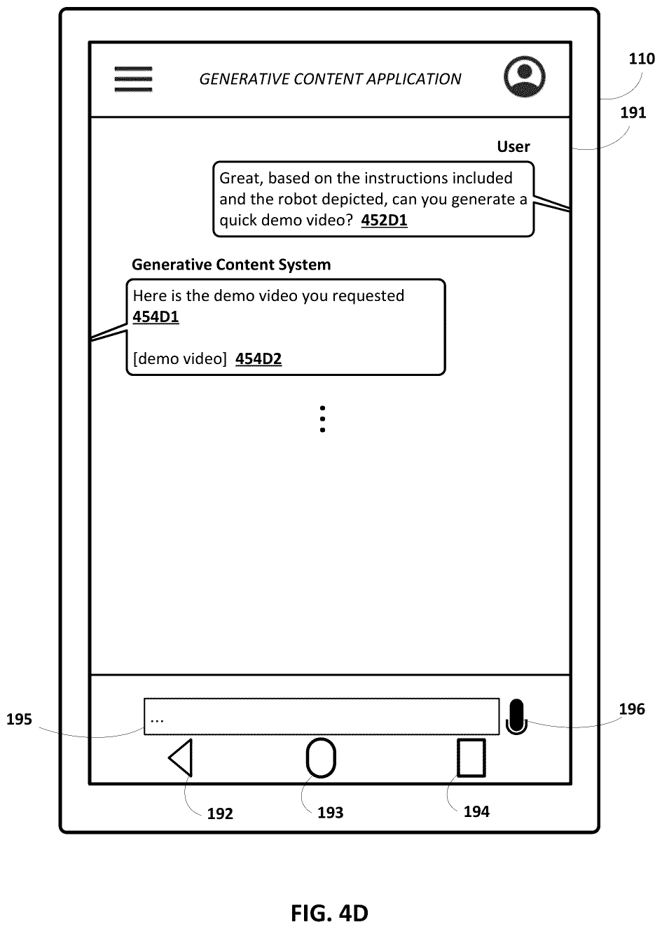

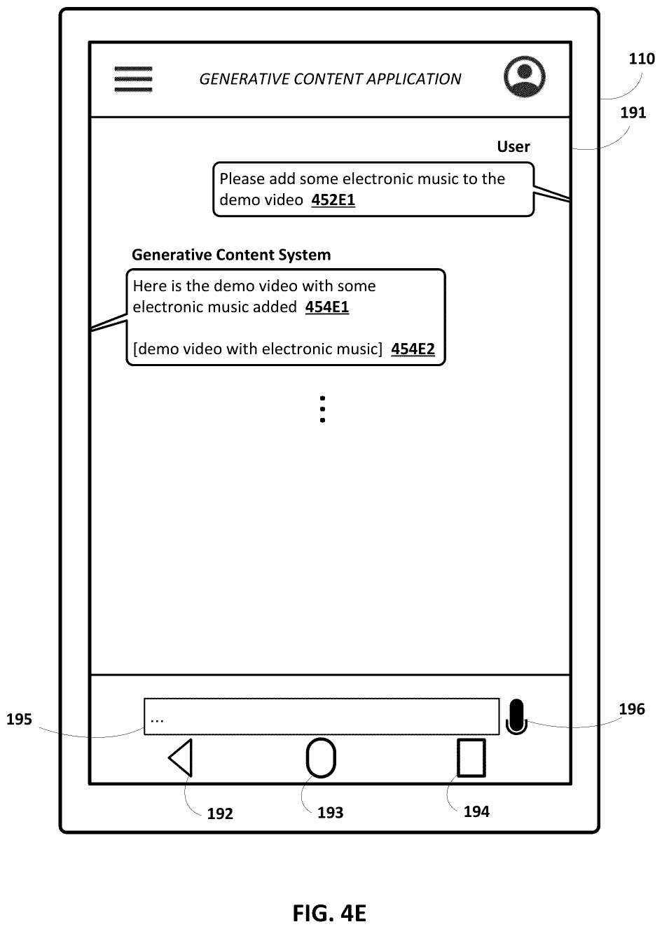

Turning now to FIGS. 4A, 4B, 4C, 4D, and 4E, various non-limiting examples of generating musical content are depicted. A client device 110 (e.g., the client device 110 from FIG. 1) may include various user interface components including, for example, microphone(s) to generate audio data based on spoken utterances and/or other audible input, speaker(s) to audibly render synthesized speech and/or other audible output, and/or a display 191 to visually render visual output. Further, the display 191 of the client device 110 can include various system interface elements 192, 193, and 194 (e.g., hardware and/or software interface elements) that may be interacted with by a user of the client device 110 to cause the client device 110 to perform one or more actions. The display 191 of the client device 110 enables the user to interact with content rendered on the display 191 by touch input (e.g., by directing user input to the display 191 or portions thereof (e.g., to a text entry box 195, to a keyboard (not depicted), or to other portions of the display 191)) and/or by spoken input (e.g., by selecting microphone interface element 196—or just by speaking without necessarily selecting the microphone interface element 196 (i.e., an automated assistant may monitor for one or more terms or phrases, gesture(s) gaze(s), mouth movement(s), lip movement(s), and/or other conditions to activate spoken input) at the client device 110). Although the client device 110 depicted in FIGS. 4A, 4B, 4C, 4D, and 4E is a mobile phone, it should be understood that is for the sake of example and is not meant to be limiting. For example, the client device 110 may be a standalone speaker with a display, a standalone speaker without a display, a home automation device, an in-vehicle system, a laptop, a desktop computer, and/or any other device capable of executing an automated assistant to engage in a human-to-computer dialog session with the user of the client device 110.

Referring specifically to FIG. 4A, assume that a user of the client device 110 accesses a generative content application, via the client device 110, that enables the user to interact with a generative content system (e.g., the generative content system 120 of FIG. 1). Further assume that the user provides user input 452A1 of “Here is a one-pager I came up with on instructions and images on how to control a robot, can you change the end effector of the robot depicted from a sucker to a gripper?” and the one-pager (e.g., image content as visual content) referenced by the user input 452A1 as indicated at 452A2. In this example, the generative content system can utilize the seed techniques and/or masking techniques described herein (e.g., with respect to FIG. 2) to change the end effector of the robot depicted in the one-pager from a sucker to a gripper. For instance, the seed techniques can be utilized to generate seed(s) for at least an image of the robot on the one-pager and textual content included on the one-pager. The seed(s) (e.g., corresponding to a portion of the one-pager that includes the sucker) can be processed and moved in embedding space to determine updated seed(s), and the updated seed(s) can be used to generate the modified version of the one-pager by changing the sucker to the gripper and without changing any of the textual content or any other content. Also, for instance, the masking techniques can be utilized to determine a bounding box or other boundary around the sucker that masks all the other content of the one-pager and image editing instructions (e.g., determined using an explicitation GM) can be utilized to generate an image of a gripper for the robot that replaces the sucker. Moreover, the generative content system can cause the modified version of the one-pager to be visually rendered at the client device 110 as indicated by 454A1 and 454A2.

Referring specifically to FIG. 4B, further assume that the user of the client device 110 continues interacting with the generative content system and provides user input 452B1 of “That looks great, can you animate the gripper to show a practical example of how it actuates?” Similar to FIG. 4A, the generative content system can utilize the seed techniques and/or masking techniques described herein (e.g., with respect to FIG. 2) to animate the gripper that replaced the sucker. For instance, the seed techniques can be utilized to generate seed(s) for at least the modified image of the robot (e.g., including the gripper instead of the sucker) on the one-pager and the textual content included on the one-pager. The seed(s) (e.g., corresponding to a portion of the one-pager that includes the gripper) can be processed and moved around as a sequence in embedding space to determine a sequence of update seed(s), and the sequence of updated seed(s) can be used to generate the further modified version of the one-pager by animating the gripper without changing any of the textual content or any other content. Also, for instance, the masking techniques can be utilized to determine a bounding box or other boundary around the gripper that masks all the other content of the one-pager and video editing instructions (e.g., determined using an explicitation GM) can be utilized to generate the animated version of the gripper for the robot that replaces the static version of the gripper. Moreover, the generative content system can cause the further modified version of the one-pager to be visually rendered at the client device 110 as indicated by 454B1 and 454B2.

Referring specifically to FIG. 4C, further assume that the user of the client device 110 continues interacting with the generative content system and provides user input 452C1 of “Awesome, can you change the font of the text so it looks more professional?” Similar to FIGS. 4A and 4B, the generative content system can utilize the seed techniques and/or masking techniques described herein (e.g., with respect to FIG. 2) to modify the font of the text. For instance, the seed techniques can be utilized to generate seed(s) for at least the modified image of the robot (e.g., including the animated version of the gripper instead of the static version of the gripper) on the one-pager and the textual content included on the one-pager. The seed(s) (e.g., corresponding to portion(s) of the one-pager that includes the text) can be processed and moved in embedding space to determine updated seed(s), and the updated seed(s) can be used to generate the further modified version of the one-pager by changing the font of the text included on the one-pager. Also, for instance, the masking techniques can be utilized to determine a bounding box or other boundary around the text of the one-pager that masks all the other content of the one-pager and text editing instructions (e.g., determined using an explicitation GM) can be utilized to generate the modified version of the text for the one-pager. Moreover, the generative content system can cause the further modified version of the one-pager to be visually rendered at the client device 110 as indicated by 454C1 and 454C2.

Referring specifically to FIG. 4D, further assume that the user of the client device 110 continues interacting with the generative content system and provides user input 452D1 of “Great, based on the instructions included and the robot depicted, can you generate a quick demo video?” Notably, and in contrast with FIGS. 4A-4C, the user in not requesting any further modifications to the visual content and/or textual content of the one-pager. Rather, the user is requesting that the generative content system generate video content that is associated with the visual content (e.g., associated with the robot that was modified through the interactions in FIGS. 4A and 4B) and the textual content (e.g., the instructions for controlling the robot as indicated in FIG. 4A) of the one-pager. Nonetheless, the generative content system can utilize the seed techniques and/or the masking techniques described herein (e.g., with respect to FIG. 2) to generate the video content request by the user. For instance, the seed techniques can be utilized to generate seed(s) for at least the modified image of the robot (e.g., including the animated version of the gripper instead of the static version of the gripper) on the one-pager and the textual content included on the one-pager. The seed(s) associated with the image of the robot can be processed and moved in embedding space to determine updated seed(s) and based on seed(s) associated with the textual content that indicate how the robot can be controlled, and the updated seed(s) can be used to generate the video content. Also, for instance, the masking techniques can be utilized to determine a bounding box or other boundary around the robot that masks all the other content of the one-pager and video editing instructions (e.g., determined using an explicitation GM and based on the textual content of the one-pager) can be utilized to generate the video content. Moreover, the generative content system can cause the video content to be visually rendered at the client device 110 as indicated by 454D1 and 454D2.

Referring specifically to FIG. 4E, further assume that the user of the client device 110 continues interacting with the generative content system and provides user input 452E1 of “Please add some electronic music to the demo video.” Similar to FIG. 4D, and in contrast with FIGS. 4A-4C, the user in not requesting any further modifications to the visual content and/or textual content of the one-pager. Rather, the user is requesting that the generative content system generate audio content to accompany the video content that was generated in the example of FIG. 4D. Accordingly, and based on the explicit instructions to generate the electronic music for the demo video, the generative content system can utilize audio generation capabilities to the requested electronic music. Moreover, the generative content system can cause the video content to be visually rendered at the client device 110 and the audio content to be audibly rendered at the client device 110 as indicated by 454E1 and 454E2.

Although FIGS. 4A-4E depict particular examples, it should be understood that is for the sake of illustrating various techniques contemplated herein and is not meant to be limiting. Further, although FIGS. 4A-4E are described with respect to techniques contemplated herein being implemented via a generative content application at the client device 110, it should be understood that is for the sake of example and is not meant to be limiting. Rather, it should be understood that various entry points to interacting with the generative content system are contemplated herein. For instance, the generative content system can be accessed by the user of the client device 110 via an automated assistant, a widget that can be invoked and overlay other software applications, a plugin or extension for a web browser, etc. Further, the generative content system can enable the modified version of the visual content to be quickly and efficiently shared (e.g., via social media, email, text message, and/or electronic communication channels), such as by enabling the modified version of the visual content to be dragged and dropped to another software application, to a message, to an email, etc.

Turning now to FIG. 5, a block diagram of an example computing device 510 that may optionally be utilized to perform one or more aspects of techniques described herein is depicted. In some implementations, one or more of a client device, multi-modal response system component(s) or other cloud-based software application component(s), and/or other component(s) may comprise one or more components of the example computing device 510.

Computing device 510 typically includes at least one processor 514 which communicates with a number of peripheral devices via bus subsystem 512. These peripheral devices may include a storage subsystem 524, including, for example, a memory subsystem 525 and a file storage subsystem 526, user interface output devices 520, user interface input devices 522, and a network interface subsystem 516. The input and output devices allow user interaction with computing device 510. Network interface subsystem 516 provides an interface to outside networks and is coupled to corresponding interface devices in other computing devices.

User interface input devices 522 may include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computing device 510 or onto a communication network.

User interface output devices 520 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 510 to the user or to another machine or computing device.

Storage subsystem 524 stores programming and data constructs that provide the functionality of some or all of the modules described herein. For example, the storage subsystem 524 may include the logic to perform selected aspects of the methods disclosed herein, as well as to implement various components depicted in FIGS. 1 and 2.

These software modules are generally executed by processor 514 alone or in combination with other processors. Memory 525 used in the storage subsystem 524 can include a number of memories including a main random-access memory (RAM) 530 for storage of instructions and data during program execution and a read only memory (ROM) 532 in which fixed instructions are stored. A file storage subsystem 526 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 526 in the storage subsystem 524, or in other machines accessible by the processor(s) 514.

Bus subsystem 512 provides a mechanism for letting the various components and subsystems of computing device 510 communicate with each other as intended. Although bus subsystem 512 is shown schematically as a single bus, alternative implementations of the bus subsystem 512 may use multiple busses.

Computing device 510 can be of varying types including a workstation, server, computing cluster, blade server, server farm, or any other data processing system or computing device. Due to the ever-changing nature of computers and networks, the description of computing device 510 depicted in FIG. 5 is intended only as a specific example for purposes of illustrating some implementations. Many other configurations of computing device 510 are possible having more or fewer components than the computing device depicted in FIG. 5.

In situations in which the systems described herein collect or otherwise monitor personal information about users, or may make use of personal and/or monitored information), the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

In some implementations, a method implemented by one or more processors is provided, and includes: receiving user input associated with a client device of a user, the user input including visual content, and the user input including a request to modify the visual content; generating a modified version of the visual content that is responsive to the user input; and causing the modified version of the visual content to be rendered at the client device. Generating the modified version of the visual content includes: processing, using a generative model (GM), GM input to generate GM output, the GM input including at least the user input and the visual content; and determining, based on the GM output, the modified version of the visual content.

These and other implementations of technology disclosed herein can optionally include one or more of the following features.

In some implementations, the visual content may include at least image content.

In some versions of those implementations, the method may further include determining that the request to modify the visual content is a request to modify one or more portions of the image content; and in response to determining that the request is a request to modify one or more of the portions of the image content: determining at least one image seed for the image content that preserves one or more additional portions of the image content that the user did not request be modified.

In some further versions of those implementations, the GM input may further include the at least one image seed, and the GM output may preserve the one or more additional portions of the image content that the user did not request be modified based on processing the GM input that further includes the at least one image seed. In additional or alternative further versions of those implementations, the at least one image seed may be a corresponding lower-level representation of the image content. In some yet further versions of those implementations, the at least one image seed may be a corresponding image embedding in a learned embedding space.

In additional or alternative versions of those implementations, the method may further include: determining that the request to modify the visual content is a request to animate one or more portions of the image content; and in response to determining that the request is a request to animate one or more of the portions of the image content: determining at least one image seed for the image content that preserves one or more additional portions of the image content that the user did not request be animated. In some further versions of those implementations, the GM input may further include the at least one image seed, and the GM output may preserve the one or more additional portions of the image content that the user did not request be animated based on processing the GM input that further includes the at least one image seed.

In additional or alternative versions of those implementations, the method may further include: determining that the request to modify the visual content is a request to add textual content that is related to the image content; and in response to determining that the request is a request to add textual content that is related to the image content: determining at least one image seed for the image content that preserves the image content. In some further versions of those implementations, the GM input may further include the at least one image seed, and the GM output may preserve the image content based on processing the GM input that further includes the at least one image seed.

In additional or alternative versions of those implementations, the method may further include: determining that the request to modify the visual content is a request to add video content that is related to the image content; and in response to determining that the request is a request to add video content that is related to the image content: determining at least one image seed for the image content that preserves the image content. In some further versions of those implementations, the GM input may further include the at least one image seed, and the GM output may preserve the image content based on processing the GM input that further includes the at least one image seed.

In additional or alternative versions of those implementations, the method may further include: determining that the request to modify the visual content is a request to add audible content that is related to the image content; and in response to determining that the request is a request to add audible content that is related to the image content: determining at least one image seed for the image content that preserves the image content. In some further versions of those implementations, the GM input may further include the at least one image seed, and the GM output may preserve the image content based on processing the GM input that further includes the at least one image seed.

In some implementations, the visual content may include video content.

In some versions of those implementations, the method may further include: determining that the request to modify the visual content is a request to modify one or more portions of the video content; and in response to determining that the request is a request to modify one or more of the portions of the video content: determining at least one video seed for the video content that preserves one or more additional portions of the video content that the user did not request be modified.

In some further versions of those implementations, the GM input may further include the at least one video seed, and the GM output may preserve the one or more additional portions of the video content that the user did not request be modified based on processing the GM input that further includes the at least one video seed. In some yet further versions of those implementations, the at least one video seed may be a corresponding lower-level representation of the video content. In additional or alternative further versions of those implementations, the at least one video seed may be a corresponding video embedding in a learned embedding space.

In additional or alternative versions of those implementations, the method may further include: determining that the request to modify the visual content is a request to add audible content that is related to the image content; and in response to determining that the request is a request to add audible content that is related to the image content: determining at least one video seed for the video content that preserves the video content. In some further versions of those implementations, the GM input may further include the at least one image seed, and the GM output may preserve the image content based on processing the GM input that further includes the at least one image seed.

In additional or alternative versions of those implementations, the method may further include: determining that the request to modify the visual content is a request to add textual content that is related to the video content; and in response to determining that the request is a request to add video content that is related to the image content: determining at least one video seed for the video content that preserves the video content. In some further versions of those implementations, the GM input may further include the at least one video seed, and the GM output may preserve the video content based on processing the GM input that further includes the at least one video seed.

In some implementations, the method may further include receiving additional user input associated with the client device of the user, the additional user input including an additional request to further modify the visual content; generating a further modified version of the visual content that is responsive to the additional user input; and causing the further modified version of the visual content to be rendered at the client device. Generating the further modified version of the visual content may include: processing, using the GM, additional GM input to generate additional GM output, the additional GM input including at least the additional user input and the modified version of the visual content; and determining, based on the additional GM output, the further modified version of the visual content.

In some versions of those implementations, the method may further include: receiving further additional user input associated with the client device of the user, the further additional user input including a further additional request to yet further modify the visual content; generating a yet further modified version of the visual content that is responsive to the further additional user input; and causing the yet further modified version of the visual content to be rendered at the client device. Generating the yet further modified version of the visual content may include: processing, using the GM, further additional GM input to generate further additional GM output, the further additional GM input including at least the further additional user input and the further modified version of the visual content; and determining, based on the further additional GM output, the yet further modified version of the visual content.

In some implementations, the visual content may be generative visual content that was previously generated using the GM or an additional GM that is in addition to the GM. In some implementations, the visual content may be non-generative visual content.

In some implementations, the method may further include, prior to receiving the user input associated with the client device of the user: fine-tuning the GM to generate the GM output based on which the modified version of the visual content is determined. In some versions of those implementations, fine-tuning the GM may include utilizing a supervised fine-tuning (SFT) technique. In additional or alternative versions of those implementations, fine-tuning the GM may include utilizing a reinforcement learning from human feedback (RLHF) technique.

In some implementations, the method may further include, prior to processing the GM input to generate the GM output and using the GM: determining at least one seed for a portion of the visual content based on the request included in the user input. The GM input may further include the one or more seeds for the visual content as the visual content for the GM input. In some further versions of those implementations, processing the GM input to generate the GM output and using the GM may include: updating, in a learned embedding space, the at least one seed based on the request included in the user input; and processing, using image generation capabilities of the GM or video generation capabilities of the GM, and based on updating the at least one seed in the learned embedding space, the modified version of the visual content as the GM output.

In some implementations, the method may further include, prior to processing the GM input to generate the GM output and using the GM: determining visual content editing instructions for the visual content based on the request included in the user input; and determining a bounding box associated with a portion of the visual content that is to be modified or a sequence of bounding boxes associated with portions of the visual content that are to be modified. The GM input may further include the visual content editing instructions and the bounding box associated with the portion of the visual content that is to be modified or the sequence of bounding boxes associated with portions of the visual content that are to be modified. In some further versions of those implementations, processing the GM input to generate the GM output and using the GM may include: processing, using image generation capabilities of the GM or video generation capabilities of the GM, the visual content editing instructions to generate a modified portion of the visual content, for the portion of the visual content included in the bounding box, or to generate modified portions of the visual content, for the portions of the visual content included in the sequence of bounding boxes, for the modified version of the visual content as the GM output.

In addition, some implementations include one or more processors (e.g., central processing unit(s) (CPU(s)), graphics processing unit(s) (GPU(s), and/or tensor processing unit(s) (TPU(s)) of one or more computing devices, where the one or more processors are operable to execute instructions stored in associated memory, and where the instructions are configured to cause performance of any of the aforementioned methods. Some implementations also include one or more non-transitory computer readable storage media storing computer instructions executable by one or more processors to perform any of the aforementioned methods. Some implementations also include a computer program product including instructions executable by one or more processors to perform any of the aforementioned methods.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

What is claimed is:

1. A method implemented by one or more processors, the method comprising:
receiving user input associated with a client device of a user, the user input including visual content, and the user input including a request to modify the visual content;
generating a modified version of the visual content that is responsive to the user input, wherein generating the modified version of the visual content comprises:
processing, using a generative model (GM), GM input to generate GM output, the GM input including at least the user input and the visual content; and
determining, based on the GM output, the modified version of the visual content; and
causing the modified version of the visual content to be rendered at the client device.

2. The method of claim 1, wherein the visual content includes at least image content.

3. The method of claim 2, further comprising:
determining that the request to modify the visual content is a request to modify one or more portions of the image content; and
in response to determining that the request is a request to modify one or more of the portions of the image content:
determining at least one image seed for the image content that preserves one or more additional portions of the image content that the user did not request be modified.

4. The method of claim 3, wherein the GM input further includes the at least one image seed, and wherein the GM output preserves the one or more additional portions of the image content that the user did not request be modified based on processing the GM input that further includes the at least one image seed.

5. The method of claim 3, wherein the at least one image seed is a corresponding lower-level representation of the image content.

6. The method of claim 5, wherein the at least one image seed is a corresponding image embedding in a learned embedding space.

7. The method of claim 2, further comprising:
determining that the request to modify the visual content is a request to animate one or more portions of the image content; and
in response to determining that the request is a request to animate one or more of the portions of the image content:
determining at least one image seed for the image content that preserves one or more additional portions of the image content that the user did not request be animated.

8. The method of claim 7, wherein the GM input further includes the at least one image seed, and wherein the GM output preserves the one or more additional portions of the image content that the user did not request be animated based on processing the GM input that further includes the at least one image seed.

9. The method of claim 2, further comprising:
determining that the request to modify the visual content is a request to add textual content that is related to the image content; and
in response to determining that the request is a request to add textual content that is related to the image content:
determining at least one image seed for the image content that preserves the image content.

10. The method of claim 9, wherein the GM input further includes the at least one image seed, and wherein the GM output preserves the image content based on processing the GM input that further includes the at least one image seed.

11. The method of claim 2, further comprising:
determining that the request to modify the visual content is a request to add video content that is related to the image content; and
in response to determining that the request is a request to add video content that is related to the image content:
determining at least one image seed for the image content that preserves the image content.

12. The method of claim 11, wherein the GM input further includes the at least one image seed, and wherein the GM output preserves the image content based on processing the GM input that further includes the at least one image seed.

13. The method of claim 2, further comprising:
determining that the request to modify the visual content is a request to add audible content that is related to the image content; and
in response to determining that the request is a request to add audible content that is related to the image content:
determining at least one image seed for the image content that preserves the image content.

14. The method of claim 13, wherein the GM input further includes the at least one image seed, and wherein the GM output preserves the image content based on processing the GM input that further includes the at least one image seed.

15. The method of claim 1, further comprising:
prior to processing the GM input to generate the GM output and using the GM:
determining at least one seed for a portion of the visual content based on the request included in the user input, wherein the GM input further includes the one or more seeds for the visual content as the visual content for the GM input.

16. The method of claim 15, wherein processing the GM input to generate the GM output and using the GM comprises:
updating, in a learned embedding space, the at least one seed based on the request included in the user input; and
processing, using image generation capabilities of the GM or video generation capabilities of the GM, and based on updating the at least one seed in the learned embedding space, the modified version of the visual content as the GM output.

17. The method of claim 1, further comprising:
prior to processing the GM input to generate the GM output and using the GM:
determining visual content editing instructions for the visual content based on the request included in the user input; and
determining a bounding box associated with a portion of the visual content that is to be modified or a sequence of bounding boxes associated with portions of the visual content that are to be modified,
wherein the GM input further includes the visual content editing instructions and the bounding box associated with the portion of the visual content that is to be modified or the sequence of bounding boxes associated with portions of the visual content that are to be modified.

18. The method of claim 17, wherein processing the GM input to generate the GM output and using the GM comprises:
processing, using image generation capabilities of the GM or video generation capabilities of the GM, the visual content editing instructions to generate a modified portion of the visual content, for the portion of the visual content included in the bounding box, or to generate modified portions of the visual content, for the portions of the visual content included in the sequence of bounding boxes, for the modified version of the visual content as the GM output.

19. A system comprising:
at least one processor; and
memory storing instructions that, when executed by the at least one processor, cause the at least one processor to be operable to:
receive user input associated with a client device of a user, the user input including visual content, and the user input including a request to modify the visual content;
generate a modified version of the visual content that is responsive to the user input, wherein the instructions to generate the modified version of the visual content comprise instructions to:
process, using a generative model (GM), GM input to generate GM output, the GM input including at least the user input and the visual content; and
determine, based on the GM output, the modified version of the visual content; and
cause the modified version of the visual content to be rendered at the client device.

20. A non-transitory computer-readable storage medium storing instructions that, when executed by at least one processor, cause the at least one processor to perform operations, the operations comprising:
receiving user input associated with a client device of a user, the user input including visual content, and the user input including a request to modify the visual content;
generating a modified version of the visual content that is responsive to the user input, wherein generating the modified version of the visual content comprises:
processing, using a generative model (GM), GM input to generate GM output, the GM input including at least the user input and the visual content; and
determining, based on the GM output, the modified version of the visual content; and
causing the modified version of the visual content to be rendered at the client device.
